(19) United States
(12) Patent Application Publication
(10) Pub. No.: US 2008/0292842 A1
(43) Pub. Date: Nov. 27, 2008

(54) Carbon Fiber Substrate and Method for Forming the Same

(75) Inventors: Bilal Zuberi, Cambridge, MA (US); James Jenq Liu, Mason, OH (US)

Correspondence Address: GEO2 TECHNOLOGIES, 12-R CABOT ROAD, WOBURN, MA, 01801, US

(73) Assignee: GEO2 TECHNOLOGIES, INC., Wobum, MA (US)

(21) Appl. No.: 11/859,309

(22) Filed: Sep. 21, 2007

Related U.S. Application Data
(63) Continuation-in-part of application No. 11/323,429, filed on Dec. 30, 2005.

(51) Int. Cl. B32B 3/12

(52) U.S. Cl. 428/116; 264/29.1

(57) ABSTRACT

A porous carbon fiber substrate and method of forming the same including providing a fiber material including carbon, providing at least one extrusion aid and providing at least one bonding phase material. The fiber material, the at least one extrusion aid and the at least one bonding phase material are mixed with a fluid. The mixed fiber material, at least one extrusion aid, at least one bonding phase material and fluid are extruded into a green honeycomb substrate. The green honeycomb substrate is fired, enabling bond formation and forming a porous carbon fiber honeycomb substrate.

### CROSS-REFERENCE TO RELATED APPLICATION

This application is a continuation-in-part of U.S. patent application Ser. No. 11/323,429, filed Dec. 30, 2005 entitled “An Extruded Porous Substrate and Products Using the Same” herein incorporated by reference in its entirety.

### FIELD OF THE INVENTION

The present invention relates to porous carbon substrates and more specifically to porous carbon substrates formed from carbon fiber materials.

### BACKGROUND

Carbon substrates are available for various filtration and separation processes. Specifically, carbon substrates may be used for water and air filtration. Carbon filters are typically effective at removing chlorine, sediment, and volatile organic compounds from water, and chemicals, volatile organic compounds and odors from air due to its chemical resistance. The surface area of a carbon substrate is typically positively charged and attracts negatively charged contaminants. Activated carbon filters are also useful in removing organic pollutants, and particularly non-ionic materials, from fluid streams. Greater surface area typically provides better filtration and adsorptive removal capabilities. One technique for providing greater surface area, in addition to the intrinsic high internal surface area of activated carbon, is to provide a highly porous, but high surface area, filter substrate, through which the medium being filtered passes. Higher porosity typically results in greater surface area, especially if the pore-structure is fully accessible and all pore-volume is accessible for fluid flow. In such a case, the pore surface area also becomes accessible for filtration and removal. In addition to filtration applications, carbon substrates may be used for a variety of applications, such as electrodes for batteries, support substrates for other materials, and as high emissivity structural materials.

Porous ceramic honeycomb substrates can be made from ceramic fibers. The advantages of a fibrous ceramic structure are the improved porosity, permeability, and specific surface area that results from the open network of pores created by the intertangled ceramic fibers, the mechanical integrity of the bonded fibrous structure, and the inherent low cost of extruding and curing the ceramic fiber substrates.

Thus, there exists a need for a high porosity carbon substrate formed from carbon fibers or fibers containing carbon, having high porosity and surface area, while the strength is maintained for various applications.

### SUMMARY

The present disclosure provides a porous carbon honeycomb substrate formed from carbon fiber materials.

In one implementation a method of forming a porous carbon fiber substrate includes providing a fiber material including carbon, providing at least one extrusion aid and providing at least one bonding phase material. The fiber material, the at least one extrusion aid and the at least one bonding phase material are mixed with a fluid. The mixed fiber material, at least one extrusion aid, at least one bonding phase material and fluid are extruded into a green honeycomb substrate. The green honeycomb substrate is fired, enabling bond formation and forming a porous carbon fiber honeycomb substrate.

The method may feature one or more of the following aspects. In some implementations, the fiber material may include one or more of graphite fiber, carbonized polyacrylonitrile (PAN) or rayon fiber, carbonized cellulose fiber, carbonized pitch fiber, and a carbonized organic fiber. The at least one extrusion aid may include an organic binder. The at least one bonding phase material may include an oxide material. The at least one bonding phase material may include a polymeric material. The at least one bonding phase material may include a metallic material. The polymeric material may include a ceramic precursor material. The at least one bonding phase material may include a glass material. The polymeric material may include a material selected from the group consisting of a water soluble resin and a coal tar pitch. The polymeric material may be carbonized during the firing step to form an activated carbon. The porous carbon fiber honeycomb substrate may have a porosity of greater than 20 percent.

Firing the green honeycomb substrate may include drying the green honeycomb substrate to remove a portion of the fluid. The green honeycomb substrate may be heated to volatilize at least a portion of the at least one extrusion aid. The green honeycomb substrate may be sintered to form bonds between the at least one bonding phase and the fiber material. Sintering the green honeycomb substrate may include forming at least one of amorphous bonds, oxide bonds, metallic bonds, ceramic bonds and carbon bonds between the at least one bonding phase and the fiber.

In another aspect, a porous carbon fiber honeycomb substrate includes an extruded composition of a fluid, at least one extrusion aid, at least one bonding phase and a fiber material including carbon. The extruded composition is fired to enable bond formation.

One or more of the following features may be included. In some embodiments, the fiber material may include one or more of graphite fiber, carbonized polyacrylonitrile fiber or rayon fiber, carbonized cellulose fiber, carbonized pitch fiber, and carbonized organic fiber. The at least one extrusion aid may include an organic binder. The at least one bonding phase material may include an oxide material. The at least one bonding phase material may include a polymeric material. The at least one bonding phase material may include a metallic material. The at least one bonding phase may include a glass material. The polymeric material may include a material selected from the group consisting of a water soluble resin and a coal tar pitch. The polymeric material may be carbonized and activated. The polymeric material may include a ceramic precursor material. The fired extruded composition may have a porosity of greater than 20 percent.

The extruded composition may be further fired to dry the extruded composition to remove at least a portion of the fluid. The extruded composition may be heated to volatilize at least a portion of the at least one extrusion aid. The extruded composition may be sintered to form bonds between the at least one bonding phase and the fiber material. The extruded composition may be sintered to form one or more of amorphous bonds, oxide bonds, metallic bonds, ceramic bonds and carbon bonds between the at least one bonding phase and the fiber material.

Details of one or more implementations are set forth in the accompanying drawings and the description below. Other features and advantages of the invention are apparent from the following description, the drawings and the claims.

### BRIEF DESCRIPTION OF THE DRAWINGS

FIG. 1 is a flowchart of an exemplary method of forming a porous carbon fiber substrate.

FIG. 2 is a flow chart of an exemplary method of sintering a green substrate.

FIG. 3 is an illustration of an exemplary substrate with honeycomb cross section.

FIG. 4 is a scanning electron microscopic image of a porous carbon fiber substrate.

### DETAILED DESCRIPTION

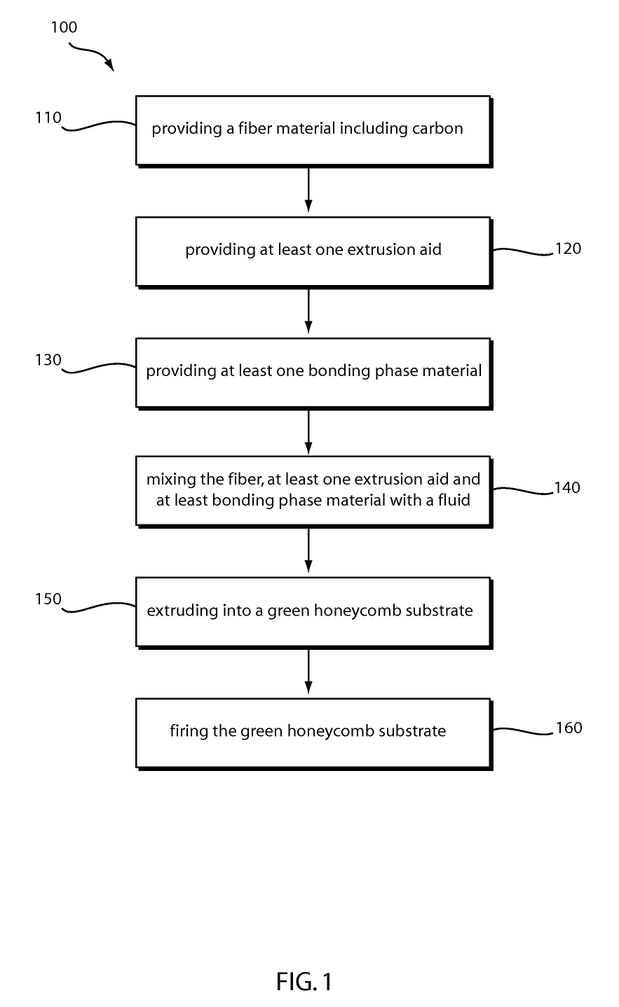

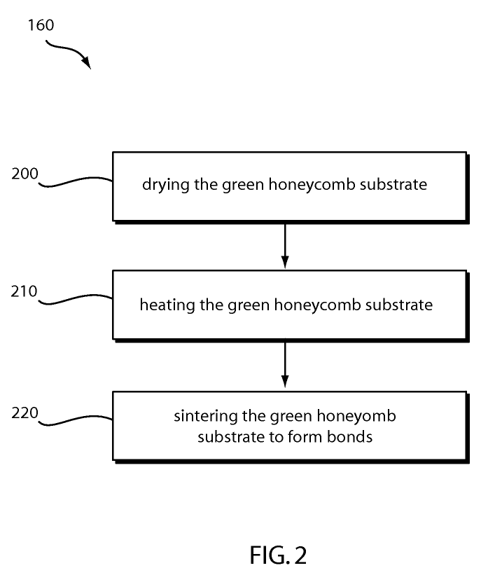

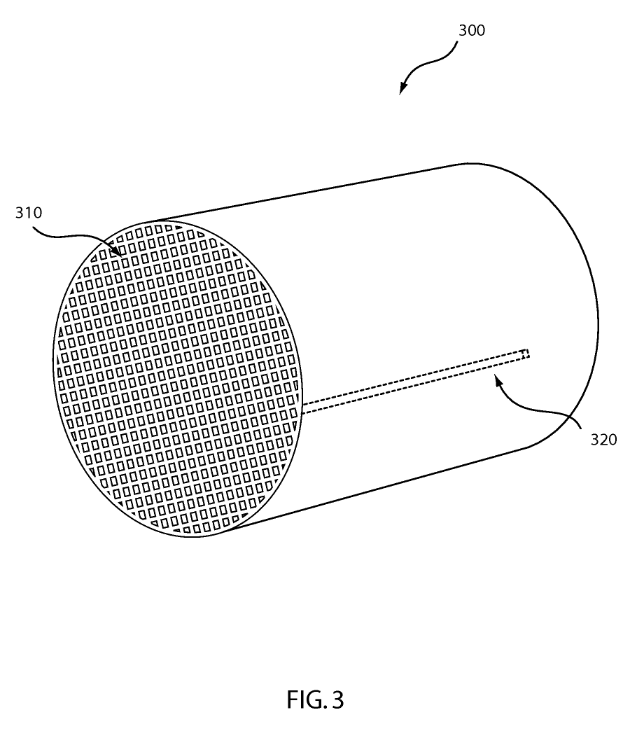

Referring to FIGS. 1, 2 and 3, an exemplary porous carbon fiber substrate 300 may be formed from materials including carbon according to an exemplary method 100 described herein. The method 100 of forming a porous carbon fiber substrate may include providing 110 a fiber including carbon. A fiber may be generally defined as a material having an aspect ratio greater than one, as compared to powder, for which the particles may have an aspect ratio of about one. The aspect ratio is the ratio of the length of the fiber divided by the diameter of the fiber. The fibrous material including carbon can be formed from polyacrylonitrile (PAN) precursors or petroleum pitch precursors, of the type commonly used in carbon-fiber reinforced composites, or a variety of carbonized organic fibers such as polymeric fibers, rayon, cellulose, cotton, wood or paper fibers, or polymeric resin filaments. The fibers can optionally be provided with a sizing coating, such as epoxy resin, glycerine (to improve dispersion), or polyurethane, as typically used in carbon-fiber reinforcement systems. As used herein, carbon fibers can be described as graphite, carbon nanotubes, carbonized cellulose and carbonized polymeric fibers, and other forms of carbon in a fiber form. The carbon fibers can be optionally provided in an activated form. Activation of carbon can be performed through physical or chemical activation, where the surface area of the carbon material is significantly increased. Physical activation occurs through carbonization, or pyrolization of the carbon fiber precursors in the range of 500-1000° C. in an inert environment, or in oxidizing environments, such as carbon dioxide, oxygen, or steam, at temperatures above 250° C. up to 1200° C. Chemical activation may include processes where the carbon fiber is impregnated with an acid solution followed by carbonization at temperatures in the range of 450-1000° C., though typically at lower temperatures and for shorter durations than physical activation.

The carbon fiber diameter may generally be in the range of about 1 to 30 microns in diameter, but carbon and carbonized fibers can also be created as thin as 100 nanometers in diameter, such as those formed through electrospinning. PAN or pitch-based fibers, and carbonized synthetic fibers, such as rayon or resin, may have more consistent fiber diameters, since the fiber diameter can be controlled when they are made. Naturally occurring fibers, such as carbonized cotton, wood, or paper fibers may exhibit an increased variation and less-controlled fiber diameter. The carbon fibers may be chopped or milled to any of a variety of lengths, e.g., to provide for convenience in handling, to provide more even distribution of fibers in the mix, and to obtain desired properties in the final substrate. Shearing forces imparted on the fibers during subsequent mixing 140 may shorten at least a portion of the fibers. The fibers may have a desired length to diameter aspect ratio between about 1 and 1,000 in their final state after extrusion, though the aspect ratio of the fibers may be in the range of about 1 to 100,000.

At least one extrusion aid may also be provided 120. Extrusion aids such as organic binders may typically be polymeric materials that, for example, when added to a suspension of particles may aid in adjusting the rheology of the suspension, e.g., through dispersion or flocculation of the particles. Water soluble organic binders, such as hydroxypropyl methyl cellulose, may work advantageously for extrusion applications, though other binders and/or mixtures of multiple binders may be used. For example, in a suspension that is too fluid for extrusion, a binder may be added to thicken, or increase the apparent viscosity of the suspension. A plastic suspension may have a relatively high shear strength, which may facilitate extrusion. In extrusion applications, binders may aid in providing plasticity and obtaining desired flow characteristics that may aid in extrusion of the material. Additionally, binders may be used to help improve the pre-firing, or green strength, of an extruded substrate. While the addition of an organic binder material has been described, other extrusion aids and/or additives may be used to aid in controlling the rheology of the suspension.

At least one bonding phase material may also be provided 130. The at least one bonding phase material may be provided 130, e.g., to provide additional strength, to aid in increasing porosity in the final fired substrate, to adjust the rheology of the mixture, to allow the inclusion of other materials for bonding in the final structure. The bonding phase material may be spherical, elongated, fibrous, or irregular in shape. The bonding phase material may increase the strength of the final substrate and may aid in the formation of porosity in a number of ways. For example, the bonding phase material may assist in fiber alignment and orientation. The bonding phase material may assist in arranging fibers into an overlapping pattern to facilitate proper bonding between fibers during firing. The arrangement of the fibers, in turn, may help to increase the strength of the final fired substrate.

Generally, in one embodiment, a glass material or an oxide-based ceramic or clay, e.g., kaolin or bentonite, may be used as the bonding phase material. Depending upon the grade of the final substrate, between 10 to 60 weight percent clay may be provided 130 as the bonding phase material. For example, a higher grade final substrate may have a relatively lower weight percent of clay added as a bonding phase material. The use of a clay as the bonding phase material may result in formation of glass/ceramic, i.e., covalent or oxide bond formation between fibers during firing (discussed in more detail below). The clay may aid in forming a network between the fibers during firing, increasing strength and porosity, while not reacting with the fibers or impairing the chemical resistance, such as through corrosion.

In another embodiment, metallic particles or a metallic solution may be used as the bonding phase material. For example, metallic particles such as titanium, silicon, nickel with a small particle size may be provided 130 as a bonding phase material. Similarly, metallic solutions such as titanium chloride and nickel chloride may be used as the bonding phase material. The use of a metallic particle or metallic solution may result in the formation of metallic bonds during firing. Depending upon the type of metallic particles or solution used as bonding phase material and the sintering temperature, a metallic phase may form between the fibers, though not reacting with the fibers, at relatively lower sintering temperatures. Alternatively, at relatively higher sintering temperatures, bonding between the fibers and metallic phase may occur, and may result in a reaction between the fibers and metal. Reaction between the fibers and the metal may result in the formation of a metal carbide, e.g. titanium carbide, nickel carbide or silicon carbide.

In a further embodiment, a polymeric material or a polymeric material including a ceramic precursor material may be used as the bonding phase material. For example, a polymeric material such as coal tar pitch or water soluble resin may be provided 130 as the bonding phase material. The polymeric materials included as bonding phase materials may burn out during firing, e.g., resulting in increased porosity of the final substrate. The carbon from the polymeric bonding phase material, which may remain after the polymeric bonding phase material has burned out during firing, may carbonize and bond with the fibers, and may result in increased strength in the final substrate. Alternatively, a polymeric material including a ceramic precursor material may be used as the bonding phase material. Polymeric materials including a ceramic precursor materials may be, for example, polymers impregnated with a ceramic precursor material such as silicon particles. An example of a polymeric material including a ceramic precursor may be, for example, polysilazanes, which may be formed using such techniques as polymer infiltration pyrolysis. The polymeric component of such material may burn off during firing, increasing porosity and leaving the silicon particles behind. The silicon particles left behind when the polymeric component is burned off during firing may bond with the fibers, in a similar manner as discussed above for metallic bonding phase materials fired at a relatively higher temperature.

The fiber, at least one extrusion aid, and the at least bonding phase material may be mixed 140 with a fluid. Mixing 140 the fibers, the at least one extrusion aid (e.g., an organic binder), the bonding phase material, and the fluid may enable suspension of the fibers in the fluid. Once the fibers are suspended, the rheology of the suspension may be further adjusted for extrusion as needed. The fibers, organic binder, bonding phase material, and fluid may be mixed 140, e.g., using a high-shear mixer, to improve dispersion of the fibers and aid in producing the desired plasticity for a particular processing application, e.g., extrusion. In an embodiment in which the suspension may include less than about 60 volume percent fiber, a resulting substrate may have greater than about 40% porosity. In other embodiments, such as with smaller diameter fibers, including, for example, nanofibers, the suspension may include less than about 80 volume percent fiber, resulting in a substrate having greater than about 20% porosity. Deionized water and/or various solvents may be used as the fluid for suspension, though other fluids such as ionic solutions may be used.

The mixture of fiber, at least one extrusion aid, the at least one bonding phase material, the fluid, and any other materials included in the mixture, may be extruded 150 to form a green honeycomb substrate (i.e., an unfired extruded article). The mixture of fiber, at least one extrusion aid, the at least one bonding phase, and the fluid may be extruded 150 using an extruder that may be, for example, a piston extruder, a single screw, or auger, extruder, or a twin screw extruder. The mixture of fiber, extrusion aid, bonding phase, fluid and other ingredients may be extruded 150 through a die configured to produce a “honeycomb” cross section 310. The honeycomb cross section 310 may be generally characterized by cells 320 that may run the length of the substrate 300. Substrates 300 with the honeycomb cross section 310 are often described by number of cells 320 per square inch.

The extruded 150 green honeycomb substrate may be fired 160, enabling consolidation and bond formation between fibers and may ultimately form a porous carbon fiber substrate. Firing 160 may include several processes. The green substrate may be dried 200 in order to remove a substantial portion of the fluid, e.g., through evaporation. Drying 200 may be controlled in order to limit defects, e.g., resulting from gas pressure build-up or differential shrinkage. Drying 200 may be conducted in open air, by controlled means, such as in a convection, conduction or radiation dryer, or within a kiln.

Firing 160 the green substrate may also include heating 210 the green substrate. As the green honeycomb substrate is heated 210, the extrusion aid may begin to burn off. Most organic binders may burn off at temperatures below 400° C. Additionally, in embodiments using a polymeric material or a polymeric material including a ceramic precursor material as the bonding phase material, the polymeric material or component may also at least partially burn off during heating 210. In embodiments in which a ceramic precursor material was used as the bonding phase material, the ceramic precursor (e.g., silicon) particles may be left behind after the polymeric material has at least partially burned off. The increase in temperature may cause the hydrocarbons in the polymer to degrade and vaporize, which may result in weight loss. Similarly, in embodiments in which a metallic solution, such as titanium chloride or nickel chloride is used as the bonding phase material, the chlorine may volatilize, leaving metallic particles behind. The organic binder burn off and chemical volatilization may enable fiber-to-fiber contact or metal-to-fiber contact, and may form an open pore network.

The dried green honeycomb substrate may be sintered 220 to enable the formation of bonds between fibers. Sintering 220 may generally involve the consolidation of the substrate, which may be characterized by the formation of bonds between the fibers to form an aggregate with strength. Several types of bonds may form during the sintering 220 process and the types of bonds formed may depend upon multiple factors, including, but not limited to, for example, the starting materials and the time and temperature of sintering 220.

In some embodiments, in which a glass or an oxide-based ceramic or clay is used as the bonding phase material, glass bonds may form between fibers. Glass bonding may be characterized by the formation of a glassy or amorphous phase at the intersection of fibers. In other instances, glass-ceramic bonds and covalent or oxide bonds may form by consolidation of a region between fibers. Glass-ceramic, and covalent/oxide bonding may be characterized by grain growth and mass transfer between overlapping fibers. Glass bonds may typically occur at lower temperatures than covalent/oxide bonds. A higher grade final substrate (e.g., a substrate including less clay in the mixture) may be fired at a higher temperature than substrates formed from mixtures including greater amounts of clay. When an oxide-based ceramic or clay is used as the bonding phase material, the green honeycomb substrate may be sintered 220 in an inert or reducing atmosphere at or near 1600° C., or depending upon the type of clay, at less than 1500° C.

In embodiments where metallic particles or a metallic solution are used as the bonding phase material (including metallic particles left behind after heating in embodiments where a ceramic precursor material was used as the bonding phase material), metallic bonds may form between fibers. As discussed above, the formation of a metallic phase may act as a glue between fibers or, at higher temperatures, the metallic particles may bond with the fibers, forming such compounds as silicon carbide, titanium carbide and nickel carbide. For example, where silicon particles are involved, the silicon may react with the carbon. The reaction between silicon and carbon typically occurs above 1300° C., with the range of about 1400° C. to 1600° C. exhibiting advantageous silicon carbide formation. When metallic particles or a metallic solution are used as the bonding phase material, an inert environment may be used for sintering 220 the green substrate. An inert environment (e.g., generally providing the absence of oxygen) may prevent the oxidation of the carbon into carbon dioxide.

In embodiments where a polymeric material or a polymeric material including a ceramic precursor material is used as the bonding phase material, the polymeric material or component may typically burn off during heating between 300° C. and 400° C. The carbon backbone of the polymeric material that is left behind after burn off may carbonize at or above 800° C. The carbon fiber, and/or the carbon backbone of the polymeric material that remains, can be activated during carbonization, or through physical or chemical activation processes during, or subsequent to firing of the substrate. When a polymeric material including a ceramic precursor material is used, the metallic particles left behind after polymer burn off may bond as described above for metallic particles.

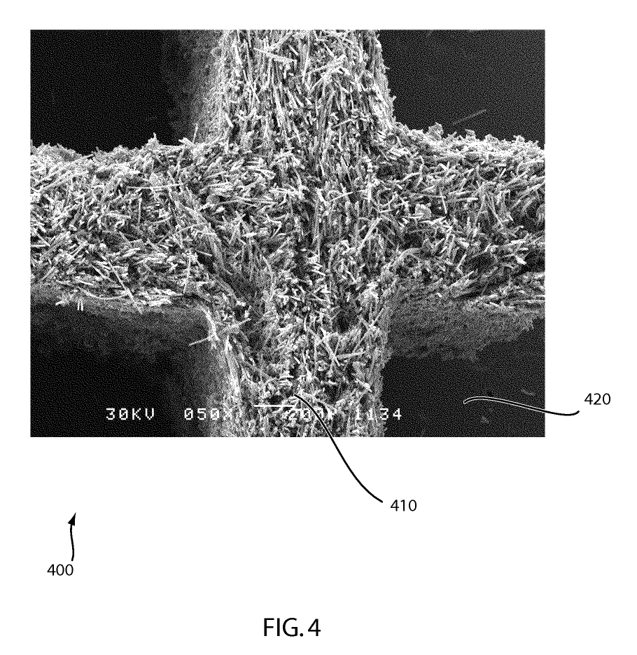

The resulting porous carbon fiber honeycomb substrate may be cooled using conventional methods. Referring to FIG. 4, a scanning electron microscopic image of an exemplary embodiment of the present invention is shown. A porous carbon fiber honeycomb substrate 400 is shown with the bonded carbon fibers forming the porous wall 410 that form channels 420. As shown in FIG. 4, the fibrous structure may be highly porous due to the interconnected pores or void space between the fibers. The strength of the substrate may be provided by the strength of the fibrous members and/or the bonds formed between adjacent and overlapping fibers. The alignment of fibers, pore size, pore distribution, nucleation, coagulation, trapping site distribution and pore characteristics of the substrate 400 can be controlled though alteration of the parameters of the extrusion process. For example, the rheology of the mixture, diameter and aspect ratio distribution of the fibers, characteristics of the binder and other ingredients, extrusion die design, and extrusion pressure and speed can be varied to attain desired characteristics in the resulting structure of the substrate. Additional processes may also be carried out either prior to, or subsequent to the sintering process, e.g., depending upon desired end use application of the substrate. For example, every other channel of the honeycomb structure of the substrate may then be plugged, e.g., to achieve a wall flow configuration when desirable for filtration processes.

The resulting porous carbon fiber honeycomb substrate can be constructed from low cell densities (e.g. 10-50 cpsi) to high cell density (200-600 cpsi). The surface area of the carbon in the substrate can be from 50 m²/g to 2000 m²/g. The cell density, wall thickness, and size of the honeycomb will depend on a variety of factors including, but not limited to, surface area and affinity of the material to be adsorbed to the carbon material, residence time of the adsorptive fluid on the carbon, flow rates, and structural integrity requirements, for example. The pore-sizes can also be tailored for specific materials to be adsorbed. For example, generally, larger pore-sizes would be better suited to absorb larger molecules, such as metals, while smaller pore-sizes are more favorable for trapping, adsorbing and retaining smaller molecules and lighter pollutants.

In an application, once all the pores of carbon are filled up with the adsorbed material, either the filter needs to be regenerated, usually through heating to a temperature sufficient to volatilize the adsorbed material, or through degassing, or washing with specific liquids to desorb the species, or through replacement of the carbon substrate with a fresh carbon substrate.

For example, porous carbon fiber honeycomb substrates can be formed using any of the following compositions of materials including carbon fiber materials.

In a first example, 35.71 weight percent carbon fiber, AGM-99 PAN-based carbon fiber having 99% purity, 7-9 μm diameter milled to approximately 150 μm length, may be mixed with 12.86 weight percent clay (Bentolite), and 7.14 weight percent HPMC with 44.29 weight percent deionized water. The mixture may be extruded into a one-inch diameter green honeycomb substrate in a 100 cells per square inch form with 0.030 inch wall thickness, dried using an RF dryer, and fired at 1400° C. for one hour in a reducing environment. The firing profile may be configured to first heat to approximately 400° C. with an air purge to burn out the HPMC organic binder, and then purge with carbon dioxide to provide a reducing environment during the high temperature firing cycle so that the carbon fibers do not oxidize while clay bonds are formed between the fibers using the Bentolite to provide strength and rigidity in the carbon fiber-based substrate.

In a second example, 29.76 weight percent carbon fiber, AGM-99 PAN-based carbon fiber having 99% purity, 7-9 μm diameter milled to approximately 150 μm length, may be mixed with 21.43 weight percent Ferro Frit 3249 (typically used in glaze coatings of pottery which contains alumina (13.3% by weight), silica (42.1%), magnesia (12.2%), boric oxide (28.9%), and calcium oxide (3.5%)), and 4.76 weight percent HPMC with 44.05 weight percent deionized water. The mixture may be extruded into a one-inch diameter green honeycomb substrate in a 100 cells per square inch form with 0.030 inch wall thickness, dried using an RF dryer, and fired at 1400° C. for one hour in a reducing environment. The firing profile may be configured to first heat to approximately 400° C. with an air purge to burn out the HPMC organic binder, and then purge with carbon dioxide to provide a reducing environment during the high temperature firing cycle so that the carbon fibers do not oxidize while glass bonds are formed between the fibers using the frit to provide strength and rigidity in the carbon fiber-based substrate.

In a third example, 25.64 weight percent carbon fiber, AGM-99 PAN-based carbon fiber having 99% purity, 7-9 μm diameter milled to approximately 150 μm length, may be mixed with 20.51 weight percent durite resin and 11.54 weight percent clay (Bentolite), and 7.69 weight percent HPMC with 34.62 weight percent deionized water. The mixture may be extruded into a one-inch diameter green honeycomb substrate in a 100 cells per square inch form with 0.030 inch wall thickness, dried using an RF dryer, and fired at 1400° C. for one hour in a reducing environment. The firing profile may be configured to first heat to approximately 400° C. with an air purge to burn out the HPMC organic binder, and then purge with carbon dioxide to provide a reducing environment during the high temperature firing cycle so that the carbon fibers do not oxidize while carbonized resin and clay bonds are formed between the fibers using the resin and Bentolite to provide strength and rigidity in the carbon fiber-based substrate.

In a fourth example, 25.64 weight percent carbon fiber, AGM-99 PAN-based carbon fiber having 99% purity, 7-9 μm diameter milled to approximately 150 μm length may be mixed with 20.51 weight percent ground pitch particles and 11.54 weight percent clay (Bentolite), and 7.69 weight percent HPMC with 34.62 weight percent deionized water. The mixture may be extruded into a one-inch diameter green honeycomb substrate in a 100 cells per square inch form with 0.030 inch wall thickness, dried using an RF dryer, and fired at 1400° C. for one hour in a reducing environment. The firing profile may be configured to first heat to approximately 400° C. with an air purge to burn out the HPMC organic binder, and then purge with carbon dioxide to provide a reducing environment during the high temperature firing cycle so that the carbon fibers do not oxidize while carbonized pitch and clay bonds are formed between the fibers using the pitch and Bentolite to provide strength and rigidity in the carbon fiber-based substrate.

Some applications where the carbon fiber-based substrate of the present invention can be used include: Hemoperfusion, heavy metal removal from fluid streams, metal extraction, spill cleanup, ground water remediation, drinking water filtration, industrial exhaust filtration, coal plant flue gas filtration, mercury separation, volatile organic compound capture from industries such as laundromats, paint shops, semi-conductor fabrication facilities, welding factories, etc, and in gas masks, gasoline tank evaporative control systems, sewage treatments, medical filtrations/adsorptive separations, heterogeneous catalysis, vodka and ethanol filtration.

It is to be understood that the foregoing description is intended to illustrate and not to limit the scope of the invention, which is defined by the scope of the appended claims. Other embodiments are within the scope of the following claims. For example, while the formation of silicon carbide is discussed, the process may be employed to form titanium carbide and nickel carbide where solutions containing titanium and/or nickel are used as the bonding phase material.

What is claimed is:

1. A method comprising:
providing a fiber material including carbon;
providing at least one extrusion aid;
providing at least one bonding phase material;
mixing the fiber material, the at least one extrusion aid and the at least one bonding phase material with a fluid;
extruding the mixed fiber material, at least one extrusion aid, at least one bonding phase material and fluid into a green honeycomb substrate; and
firing the green honeycomb substrate enabling bond formation and forming a porous carbon fiber honeycomb substrate.

2. The method of claim 1, wherein the fiber material includes one or more of graphite fiber, carbonized PAN fiber, carbonized petroleum pitch fiber, rayon fiber, carbonized cellulose fiber and a carbonized organic fiber.

3. The method of claim 1, wherein the at least one extrusion aid includes an organic binder.

4. The method of claim 1, wherein the at least one bonding phase material includes an oxide material.

5. The method of claim 1, wherein the at least one bonding phase material includes a polymeric material.

6. The method of claim 1, wherein the at least one bonding phase material includes a metallic material.

7. The method of claim 5, wherein the polymeric material includes a ceramic precursor material.

8. The method of claim 1, wherein the at least one bonding phase material includes a glass material.

9. The method of claim 1, wherein the porous carbon fiber honeycomb substrate has a porosity of greater than 20 percent.

10. The method of claim 5, wherein the polymeric material includes a material selected from the group consisting of a water soluble resin and a coal tar pitch.

11. The method of claim 10, wherein the polymeric material is carbonized during the firing step to form an activated carbon.

12. The method of claim 1, wherein firing the green honeycomb substrate includes:
drying the green honeycomb substrate to remove a portion of the fluid;
heating the green honeycomb substrate to volatilize at least a portion of the at least one extrusion aid; and
sintering the green honeycomb substrate to form bonds between the at least one bonding phase material and the fiber material.

13. The method of claim 12, wherein sintering the green honeycomb substrate includes forming at least one of amorphous bonds, oxide bonds, metallic bonds, ceramic bonds and carbon bonds between the at least one bonding phase material and the fiber.

14. The method of claim 1 wherein the firing step further comprises activating the fiber material including carbon.

15. A porous carbon fiber honeycomb substrate comprising:
an extruded composition of a fluid, at least one extrusion aid, at least one bonding phase material and a fiber material including carbon, the extruded composition being fired to enable bond formation.

16. The porous carbon fiber honeycomb substrate of claim 15, wherein the fiber material includes one or more of graphite fiber, carbonized PAN fiber, carbonized petroleum pitch fiber, rayon fiber, carbonized cellulose fiber and carbonized organic fiber.

17. The porous carbon fiber honeycomb substrate of claim 15, wherein the at least one extrusion aid includes an organic binder.

18. The porous carbon fiber honeycomb substrate of claim 15, wherein the at least one bonding phase material includes an oxide material.

19. The porous carbon fiber honeycomb substrate of claim 15, wherein the at least one bonding phase material includes a polymeric material.

20. The porous carbon fiber honeycomb substrate of claim 15, wherein the at least one bonding phase material includes a metallic material.

21. The porous carbon fiber honeycomb substrate of claim 15, wherein the at least one bonding phase material includes a glass material.

22. The porous carbon fiber honeycomb substrate of claim 15, wherein the fired extruded composition has a porosity of greater than 20 percent.

23. The porous carbon fiber honeycomb substrate of claim 19, wherein the polymeric material includes a material selected from the group consisting of a water soluble resin and a coal tar pitch.

24. The porous carbon fiber honeycomb substrate of claim 19, wherein the polymeric material includes a ceramic precursor material.

25. The porous carbon fiber honeycomb substrate of claim 15, wherein the extruded composition is further fired to:
dry the extruded composition to remove at least a portion of the fluid;
heat the extruded composition to volatilize at least a portion of the at least one extrusion aid; and
sinter the extruded composition to form bonds between the at least one bonding phase material and the fiber material.

26. The porous carbon fiber honeycomb substrate of claim 23, wherein the extruded composition is sintered to form one or more of amorphous bonds, oxide bonds, metallic bonds, ceramic bonds and carbon bonds between the at least one bonding phase material and the fiber material.

27. The porous carbon fiber honeycomb substrate of claim 23, wherein the polymeric material is carbonized and activated.

28. The porous carbon fiber honeycomb substrate of claim 15, wherein the fiber material comprises an activated carbon.
